(19) United States
(12) Patent Application Publication
(10) Pub. No.: US 2022/0363914 A1
(43) Pub. Date: Nov. 17, 2022

(54) AQUEOUS EPOXY RESIN BASED SHOP PRIMER

(71) Applicant: GUANGDONG HUARUN PAINTS CO., LTD., Foshan, Guangdong (CN)

(72) Inventors: Chao JIANG, Foshan, Guangdong (CN); JIanning XIE, Foshan, Guangdong (CN); Ping ZHANG, Foshan, Guangdong (CN)

(21) Appl. No.: 17/755,389

(22) PCT Filed: Nov. 23, 2020
(86) PCT No.: PCT/CN2020/130915

§ 371 Date: Apr. 28, 2022

(30) Foreign Application Priority Data
Dec. 4, 2019 (CN) 201911225745.7

(51) Int. Cl. C09D 5/00; C09D 5/24; C09D 7/61; C09D 7/20; C09D 163/00

(52) U.S. Cl. CPC C09D 5/002; C09D 5/24; C09D 7/61; C09D 7/20; C09D 163/00

(57) ABSTRACT

The present disclosure relates to an aqueous epoxy resin based shop primer comprising: a) a film-forming resin composition comprising: i) an epoxy resin component; and ii) an aqueous carrier; b) an aqueous curing system comprising an epoxy reactive curing agent; wherein the epoxy resin component comprises: an epoxy resin matrix and a rubber modified epoxy resin; and wherein the shop primer is substantially free of zinc. The present disclosure also relates to an article comprising a metal substrate having at least one major surface; and a shop primer layer formed by the above mentioned aqueous epoxy resin-based shop primer directly applied to the major surface.

### TECHNICAL FIELD

The present disclosure relates to an aqueous epoxy resin based shop primer, more particularly to an aqueous zinc-free epoxy resin based shop primer having excellent corrosion resistance.

### BACKGROUND

Large metal objects such as cargo containers are typically assembled by welding together a number of individual components made of iron, steel or other conductive metals. To prevent the various components from corroding prior to assembly, the components may cleaned such as by shot blasting, grinding or other abrasion or ablative processes, and then coated with a corrosion-inhibiting temporary primer. Therefore, this kind of corrosion-inhibiting temporary primer, also known as a shop primer, is an important coating that provides corrosion resistance for metal products.

At present, zinc-rich epoxy coatings are still one of the most important anti-corrosion coatings for ships, marine engineering, steel structures, and the like, and they have excellent anti-corrosion performances. The corrosion resistance of this zinc-rich epoxy primer may be achieved due to the presence of a large amount of zinc powder in the system. Zinc is a metal having higher activity than iron and easily loses electrons. When zinc powder and a steel or iron substrate both are present to form a primary cell, the metal iron substrate is cathodically protected by zinc powder since zinc has an electrode potential lower than iron and is used as a sacrificial anode, the steel or iron substrate is used as a cathode, and the current flows from zinc to iron. At the same time, the zinc-rich coating is continuously corroded during the application process, and a corrosion product, namely basic zinc carbonate, commonly known as “white rust”, is deposited surrounding the zinc powder and on the surface of the steel substrate. The corrosion product has a dense structure and is not conductive, which is an insoluble stable compound and thus can block and shield the substrate against corrosion from a corrosive media and has a unique “self-repair” characteristic. Therefore, a coating system consisting of the zinc-rich epoxy primer, an intermediate coating and a topcoat can reach an anti-corrosion life of more than 15 years, which is currently the most commonly used anti-corrosion coating system for steel structures.

However, since the zinc-rich primer usually has a high content of zinc powder, up to 85% or 95%, the resulting paint film from the zinc-rich paint will have a large amount of zinc overflow during a welding and cutting flame operation, and the generated zinc steam will bring about serious harm to the health of personnel and the operators are prone to cause hot zinc disease.

In addition, conventional epoxy shop primers are solvent-borne epoxy shop primers, and water-based epoxy shop primers usually would be difficult to meet applicable performance requirements and standards. With the increasing concern of environment, there is a major challenge in the coating industry from a solvent-based coating system to a water-borne coating system.

Therefore, there is a need in the coating art to an aqueous zinc-free epoxy shop primer with good corrosion resistance.

### SUMMARY

The present disclosure provides an aqueous epoxy resin based shop primer comprising: a) a film-forming resin composition comprising: i) an epoxy resin component; and ii) an aqueous carrier; b) an aqueous curing system comprising an epoxy reactive curing agent; wherein the epoxy resin component comprises: an epoxy resin matrix and a rubber modified epoxy resin; and wherein the shop primer is substantially free of zinc.

The present disclosure also provide an article, comprising a metal substrate having at least one major surface; and a shop primer layer formed by the aqueous epoxy resin-based shop primer according to the present disclosure directly applied to the major surface. Preferably, the metal substrate is selected from the group consisting of steel, iron, aluminum, zinc, and alloys thereof.

The inventors of the present disclosure have surprisingly found that in the formulation of an aqueous epoxy resin-based shop primer, an epoxy resin component comprising an epoxy resin matrix and a rubber modified epoxy resin constituted as a portion of a film-forming resin composition and the resulting paint film from the aqueous epoxy resin-based shop primer may achieve excellent anti-corrosion performance in the absence of zinc, which was unforeseen prior to the present disclosure. As we all know, most of the shop primers with excellent anti-corrosion performances on the market at present are made by mixing a large amount of zinc powder in their formulations to make the zinc powder “sacrifice” itself to slow down the corrosion (also known as a cathodic protection) from environment on the substrate, thereby obtaining corrosion resistance. Therefore, currently available zinc-free shop primers with excellent anti-corrosion performances are very limited.

Without wishing to be bound by any theory, it is speculated that the aqueous epoxy resin shop primer according to the present disclosure free of zinc may achieve the above corrosion resistance for the following mechanism.

The aqueous epoxy resin-based shop primer of the present invention comprises an epoxy resin component comprising an epoxy resin matrix and a rubber-modified epoxy resin, which constitutes the main body of the film-forming resin composition. The shop primer with such a composition after forming a paint film can prevent a corrosive medium from contacting the surface of substrate and can cut off the pathway of the corrosive battery, and increase the resistance, thereby improving corrosion resistance of the coating. In embodiments of the present invention, the paint film formed from the aqueous epoxy resin based shop primer according to the present disclosure can effectively prevent water vapor from reaching the surface of the substrate, and can effectively prevent oxygen from reaching the surface of metal, thereby achieving excellent anticorrosive performance.

### Definition

As used herein, “a”, “an”, “the”, “at least one”, and “one or more” are used interchangeably. Thus, for example, a coating composition that comprises “an” additive can be interpreted to mean that the coating composition includes “one or more” additives.

Throughout the present invention, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this invention, as along as such components or steps do not affect the basic and novel characteristics of the invention, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

The term “shop primer” (sometimes also called a preconstruction primer or a precoated primer) refers to a short-term or temporary primer composition for use on a bare metallic component prior to final assembly and application of a permanent primer and permanent protective or decorative topcoat. If the shop primer is applied in one or more layers to a bare metallic substrate and left uncoated without a topcoat, it may be incapable of withstanding extended exposure to corrosive conditions (e.g., one week of salt spray exposure) without visually objectionable deterioration or corrosion, but may provide adequate corrosion inhibition during such shorter time periods or less stringent conditions as may arise in a typical manufacturing operation.

When used with respect to “epoxy resin based shop primer”, the term “substantially free of zinc ” means that the shop primer contains less than 1 wt %, preferably less than 0.5 wt %, more preferably less than 0.1 wt %, even more preferably less than 0.05 wt %, or particularly preferably less than 0.01 wt % of zinc, based on the total weight of the shop primer. Zinc comprises elemental zinc, but also zinc compound or its combination. As an illustrative illustration, zinc may be zinc, zinc salt and/or zinc oxide.

When used with respect to “epoxy based shop primer”, the term “film forming resin composition” refers to a composition which may be applied to a substrate and which when dried, crosslinked or otherwise hardened with an appropriate curing agent provide a tack-free continuous film sufficiently well adhered to the substrate.

When used with respect to “film forming resin composition”, the term “epoxy resin component” refers to a resin composition contained in the film forming resin composition which when dried, crosslinked or otherwise hardened with an appropriate curing agent, if necessary, provide a tack-free continuous film sufficiently well adhered to the substrate.

When used with respect to “epoxy resin component”, the term “epoxy resin matrix” refers to a component that constitutes the main body of the epoxy resin component, which has a higher content than other components in the epoxy resin component, such as rubber modified epoxy resin, and which can provide the mechanical strength of the resulting paint film from the present aqueous epoxy resin based shop primer.

When used with respect to “epoxy resin component”, the term “rubber modified epoxy resin” refers to a component that forms a part of the epoxy resin component, which can not only provide the mechanical strength of the resulting paint film from the present aqueous epoxy resin based shop primer, but also provide the barrier performance of the resulting paint film from the present aqueous epoxy resin based shop primer. In one embodiment of the present invention, the rubber modified epoxy resin is an epoxy resin with a rubber molecule on the main chain, at the terminal or on pendent chain of the epoxy resin, which is usually obtained by toughening a bisphenol-A type epoxy resin with the rubber molecule.

As used herein, the term “epoxy equivalent” refers to the mass of the resin containing 1 mole of epoxy group. Generally, the lower the epoxy equivalent, the more epoxy groups contained in the resin, and the higher the reaction activity is. In an embodiment of the present invention, the epoxy equivalent value of a resin is usually provided by the supplier of the resin.

The term “comprises”, “comprising”, “contains” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

### DETAILED DESCRIPTION

The present disclosure provides an aqueous epoxy resin based shop primer comprising: a) a film-forming resin composition comprising: i) an epoxy resin component; and ii) an aqueous carrier; b) an aqueous curing system comprising an epoxy reactive curing agent; wherein the epoxy resin component comprises: an epoxy resin matrix and a rubber modified epoxy resin; and wherein the shop primer is substantially free of zinc.

In the field of corrosion protection, most of the existing shop primers is achieved by “sacrificing” zinc powder to slow down the corrosion process, and the zinc free anti-corrosion shop primer is limited. As an available product of a zinc free anti-corrosion shop primer, the Chinese patent application No. CN102211430B assigned to Valspar Corporation, USA has proposed a waterborne autoweldable shop primer, which discloses a shop primer formulated with a styrene acrylic resin emulsion as a resin component, and containing less than 1 wt % of zinc. The resin system as proposed is a styrene acrylic emulsion system, which is obviously different from the epoxy system of the present invention. Moreover, the application mainly focuses on automatic welding, and does not disclose and teach its anti-corrosion performance, let alone teach and motivate how to achieve good corrosion resistance by selecting a specific epoxy resin.

The inventors of the present invention have found that in the formulation of a shop primer, an epoxy resin component comprising an epoxy resin matrix and a rubber modified epoxy resin constituted as a portion of a film-forming resin composition and likewise as a main portion of the resulting paint film from the shop primer, so that the paint film can effectively prevent water vapor from reaching the surface of the substrate, and can effectively prevent oxygen from reaching the surface of metal, thereby obtaining an epoxy resin based shop primer free of zinc with an excellent anticorrosive performance.

In embodiments of the present invention, the aqueous epoxy resin based shop primer is substantially free of zinc, i.e., does not contain a significant amount (e.g., ≤1 wt %, ≤0.5 wt %, or ≤0.1 wt %) of zinc. According to the present disclosure, zinc may be an elemental zinc, such as zinc powder, or may be derived from various zinc compounds, including but not limited to zinc oxide, zinc salts (such as zinc silicate or ethyl zinc silicate) or combinations thereof.

### Film Forming Resin Composition

In the present disclosure, the film-forming resin composition is a composition that constitutes the main body of the resulting paint film from the aqueous epoxy resin based shop primer of the present disclosure, comprising an epoxy resin component, an aqueous carrier, optionally conductive filler and additional additives.

According to the present disclosure, the epoxy resin component is a resin composition contained in the film forming resin composition which when dried, crosslinked or otherwise hardened with an appropriate curing agent, if necessary, may provide a tack-free continuous film sufficiently well adhered to the substrate.

In embodiments of the present disclosure, the epoxy resin component comprises an epoxy resin matrix. As used herein, the term “epoxy resin matrix” refers to a component that constitutes the main body of the epoxy resin component, which has a higher content than other components in the epoxy resin component, and which can provide the mechanical strength of the resulting paint film from the aqueous epoxy resin based shop primer of the present disclosure. The term “epoxy resin” as used herein refers to a polymer or oligomer containing two or more epoxy groups in one molecule. Preferably, the epoxy resin may contain at most four epoxy groups in one molecule. Preferably, the epoxy resin may contain two or three epoxy group in one molecule.

According to some embodiments of the preset invention, the epoxy resin may have an epoxy equivalent varying over a wide range, wherein the epoxy equivalent is the mass of an epoxy resin containing 1 mole of epoxy group. For example, the epoxy resin may comprise a low epoxy equivalent epoxy resin and a high epoxy equivalent epoxy resin. As used herein, the epoxy resin having an epoxy equivalent between 400-700g/eq, preferably between 450-550 g/eq is known as a low epoxy equivalent epoxy resin. The epoxy resin having a higher epoxy equivalent, such as having an epoxy equivalent greater than 800 g/eq, is known as a high epoxy equivalent epoxy resin. Preferably, the high epoxy equivalent epoxy resin may have an epoxy equivalent in the range of 900 g/eq to 2500 g/eq. In some embodiments, the high epoxy equivalent epoxy resin may have an epoxy equivalent in the range of 850 g/eq to 1200 g/eq. In some embodiments, the high epoxy equivalent epoxy resin may have an epoxy equivalent in the range of 1400 g/eq to 2500 g/eq, for example, in the range of 1600-1800 g/eq, or in the range of 1700-2200 g/eq.

Suitable epoxy resin comprises, for example diglycidyl ether of polyhydric phenol, such as diglycidyl ether of resorcinol, diglycidyl ether of catechol, diglycidyl ether of hydroquinone, diglycidyl ether of bisphenol A, diglycidyl ether of bisphenol F, diglycidyl ether of bisphenol S, diglycidyl ether of tetramethyl bisphenol; diglycidyl ether of polyalcohol, such as diglycidyl ether of aliphatic diglycol and diglycidyl ether of polyether glycol, for example diglycidyl ether of C₂₋₂₄ alkylene glycol, diglycidyl ether of poly(ethylene oxide) glycol or diglycidyl ether of poly(propylene oxide) glycol; or polyglycidyl ether of novolack resin, such as polyglycidyl ether of phenol-formaldehyde resin, polyglycidyl ether of alkyl substituted phenol-formaldehyde resin, polyglycidyl ether of phenol-hydroxyl benzaldehyde resin, or polyglycidyl ether of cresol-hydroxyl benzaldehyde resin; or the combination thereof.

According to some embodiments of the present disclosure, the epoxy resin is diglycidyl ether of polyhydric phenol, especially preferably having the structure of formula (I):

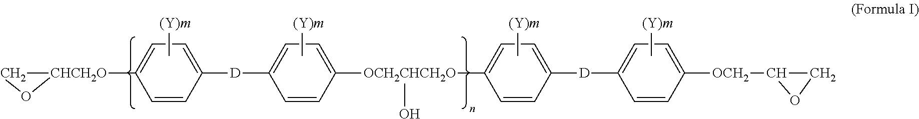

wherein
D each represents —S—, —S—S—, —SO—, —SO₂—, —CO₂—, —CO—, —O— or C₁ to C₁₀ alkylene, preferably C₁ to C₅ alkylene, more preferably C₁ to C₃ alkylene, such as —CH₂— or —C(CH₃)₂—,
Y each independently represents halogen, such as F, Cl, Br, or I, or optionally substituted monovalent C₁ to C₁₀ hydrocarbon group, such as optionally substituted methyl, ethyl, vinyl, propyl, allyl or butyl;
m each independently represents 0, 1, 2, 3 or 4, and
n represents an integer from 0 to 4, such as 0, 1, 2, 3 or 4.

More preferably, the epoxy resin is bisphenol A epoxy resin, bisphenol S epoxy resin or bisphenol F epoxy resin having the structure of formula (I) in which D represents —C(CH₃)₂—, —SO₂— or —CH₂— respectively, m represents 0, and n represents an integer from 0 to 4.

Most preferably, the epoxy resin is bisphenol A epoxy resin having the structure of formula (I) in which D represents —C(CH₃)₂—, m represents 0, and n represents an integer from 0 to 4.

The epoxy resin as disclosed in the present disclosure may be prepared by the epichlorohydrin technology which is well-known by those skilled in the art, for example. Alternatively, as an example of epoxy resin, any suitable commercial product may be used, for example E55, E51, E44, or E20 available from Kaiping Resin Company, Shanghai, China.

According to the present disclosure, the epoxy resin matrix is used as a resin component of the aqueous epoxy resin based shop primer of the present disclosure. In one aspect, the resin component functions as a binder which provides adhesion to a substrate, and holds together other components, such as fillers, of the epoxy resin component to impart basic cohesive strength to the paint film forming from the aqueous epoxy resin based shop primer of the present disclosure. In the other aspect, the resin component has good reactivity with a curing agent, thereby providing a coating having high mechanical strength.

In the epoxy resin component according to the present invention, the epoxy resin matrix is present in the form of an aqueous epoxy resin emulsion. As an example of the epoxy resin matrix, any suitable commercially available product can be used, such as Allnex 387 from Allnex Corporation USA, 3907 from Huntsman, 900 and 1600 from Nanya, or EPIKOTE™ Resin 6520 from Hexion. Preferably, the aqueous epoxy resin emulsion has a solid content of 40-60 wt %.

Preferably, the film-forming resin composition comprises about 22% to about 25 wt % of the epoxy resin matrix relative to the total weight of the film-forming resin composition. Particularly, the film-forming resin composition, relative to the total weight of the film-forming resin composition, comprises about 22 wt %, or about 23 wt %, or about 24 wt % or about 25 wt % of the epoxy resin matrix.

In embodiments according to the present invention, the epoxy resin component further comprises a rubber-modified epoxy resin. According to the present invention, the rubber-modified epoxy resin is an important component of the epoxy resin component, which can substantially improve performances of the resulting paint film from the aqueous epoxy resin based shop primer of the present disclosure, including but not limited to impact resistance and corrosion resistance. In the present invention, “rubber-modified epoxy resin” refers to an epoxy resin with a rubber molecule on the backbone, at the terminal or in the pendant chain of the epoxy resin. The rubber-modified epoxy resin is also used to provide a resin component for the aqueous epoxy resin based shop primer of the present disclosure. In one aspect, the resin component functions as a binder which provides adhesion to a substrate, and holds together other components, such as fillers, of the epoxy resin component to impart basic cohesive strength to the resulting paint film from the aqueous epoxy resin based shop primer of the present disclosure. In the other aspect, the resin component has good reactivity with a curing agent, thereby providing beneficial impact resistance and corrosion resistance to the resulting paint film from the aqueous epoxy resin based shop primer of the present disclosure.

According to some embodiments of the present invention, the rubber-modified epoxy resin has an epoxy equivalent in the range of 450 g/eq to 620 g/eq, preferably in the range of 480 g/eq to 600 g/eq, more preferably in the range of 480 g/eq to 590 g/eq, and even more preferably 500 g/eq to 600 g/eq.

In some embodiments according to the present invention, the rubber-modified epoxy resin has a glass transition temperature of 10° C. or lower, preferably a glass transition temperature of 0° C. or lower, wherein the glass transition temperature is measured by DSC.

In a preferred embodiment of the present invention, the rubber modified epoxy resin is obtained by toughening a bisphenol-A type epoxy resin by rubber molecules. Compared with the epoxy resin matrix itself and the combination of the epoxy resin matrix and conventional modifiers, the kind of rubber-modified epoxy resin when used in combination with the epoxy resin matrix can more significantly improve the corrosion resistance of the resulting paint film from the aqueous epoxy resin based shop primer of the present disclosure. In one embodiment of the present invention, “rubber molecule” is used as a flexible functional block of the rubber-modified epoxy resin, which is selected from one or more of carboxyl terminated nitrile rubber, hydroxyl terminated nitrile rubber, polysulfide rubber, nitrile rubber based isocyanate prepolymer, hydroxyl terminated polybutadiene, polyether rubber, urethane rubber and silicone rubber. In one embodiment of the present invention, “bisphenol-A type epoxy resin” is used as a rigid epoxy block of the rubber-modified epoxy resin, which has an epoxy equivalent in the range of 500-575 g/eq.

In the epoxy resin component according to the present invention, the rubber-modified epoxy resin is in the form of a dispersion in an aqueous solvent. As an example of the rubber-modified epoxy resin, any suitable commercially available products can be used, such as HEXION™ series products, such as EPIKOTE Resin 6530, EPIKOTE™ Resin 6533, EPON Resin 58005, EPON Resin 58006, EPON Resin 58034, EPON Resin 58901. Preferably, the rubber-modified epoxy resin emulsion has a solid content of 40-65 wt %.

Preferably, the film-forming resin composition comprises about 5% to about 8 wt % of the rubber-modified epoxy resin relative to the total weight of the film-forming resin composition. Particularly, the film-forming resin composition comprises about 6 wt %, or about 6.5 wt %, or about 7 wt % or about 7.5 wt % of the rubber modified epoxy resin relative to the total weight of the film-forming resin composition.

Preferably, the film forming resin composition of the present disclosure may further comprise an electrically conductive filler.

A variety of conductive materials may be used in the disclosed epoxy resin based shop primer. Exemplary conductive materials include particles, fibers, platelets and other shapes that can be uniformly dispersed throughout the aqueous epoxy resin based shop primer. Preferred conductive materials may for example include carbon, calcium, cobalt, copper, iron, nickel and a variety of other less widely-used conductive materials. More expensive materials such as silver or antimony tin oxide may be used. Preferably the chosen conductive material reduces or at least does not aggravate corrosion of primed but otherwise uncoated parts. Mixtures of conductive materials may be employed.

Exemplary carbonaceous materials include conductive carbon blacks such as acetylene blacks, furnace blacks produced from oil feed stocks, carbon fibers, graphite, as well as combination carbon-containing materials such as nickel-coated graphite powder. Exemplary commercially available carbonaceous materials include conductive carbons from AkzoNobel Polymer Chemicals including KETJENBLACK™ EC carbon blacks; conductive graphites, carbon fibers and carbon blacks available from Asbury Carbons; conductive carbons from Cabot Corp. including VULCAN™ XC conductive carbon black; conductive carbons from Columbian Chemicals Company including CONDUCTEX™ 975 Ultra and CONDUCTEX SC Ultra carbon blacks; conductive carbons from Continental Carbon including N120, N121. N234, LH30, N326, N330, N339, N343, N351 and N550 carbon blacks; conductive carbons from Lion Corporation; conductive carbons from Timcal Graphite & Carbon including ENSACO™ 150G, ENSACO 210G, ENSACO 250G, ENSACO 260G and ENSACO 350G conductive carbon blacks; and E-FILL™ nickel-coated graphite powders from Sulzer Metco Canada.

Exemplary commercially available metallic materials include aluminum powders from Alcoa Aluminum Powder, from Eckart America and from Silberline Manufacturing Company; antimony-doped tin oxide powders from Milliken & Company including ZELEC™ ECP powders such as ZELEC ECP 1410-T powder; copper powders and flakes from Ferro Corporation including Copper Powder 8ED; copper powders from Sarda Industrial Enterprises; iron powders from Bayer Corporation, from BASF Corporation, from Cathay Pigments USA, from Haubach GmbH, from Hoover Color Corporation and from Toho Zinc Co. Ltd.; and nickel powders from Sulzer Metco Canada including E-FILL™ nickel powders; and ferrophosphorus powder including ultrafine ferrophosphorus powder. Exemplary commercially available coated metallic materials include CONDUCT-O-FILT™ coated conductive materials from Potters Industries. A variety of additional conductive materials are available from Reade Advanced Materials.

The electrical conductivity and loading level for the chosen conductive material desirably is sufficient to provide an autoweldable shop primer. The disclosed shop primer preferably are free of or substantially free of cadmium and other harmful heavy metals which when welded may cause airborne emission of unsafe vapors, objectionable volatilization or combustion products, metal fume fever, or weld contamination.

The conductive material may for example represent at least about 0.5 wt %, at least about 1 wt %, at least about 2 wt % or at least about 3 wt % of the film forming resin composition, and up to about 30 wt %, up to about 20 wt %, up to about 10 wt % or up to about 7 wt % of the film forming resin composition. In general, lower amounts of carbonaceous conductive materials and higher amounts of metallic conductive materials may be employed, with the desired amount generally being selected empirically based on coating and welding performance. In a preferred embodiment of the present disclosure, the conductive filler preferably represent about 4 wt % to about 7 wt % of the film forming resin composition.

Preferably, in the film-forming resin composition according to the present invention, the aqueous carrier may further include an alcohol solvent in addition to water. The alcohol solvent as added may increase volatilization rate of the aqueous epoxy resin based shop primer of the present disclosure and accelerate the formation of the resulting paint film therefrom. In some embodiments of the present invention, the alcohol solvent includes ethanol, propanol, 1-methoxy-2-propanol or any combination thereof.

The aqueous carrier may, for example, represent at least about 20 wt %, at least about 21 wt %, at least about 22 wt % or at least about 23 wt % of the film-forming resin composition, and up to about 35 wt %, at most about 34 wt %, up to about 33 wt %, up to about 32 wt %, or up to about 21 wt % of the film-forming resin composition. Generally, a higher amount of alcohol solvent can be used, and the desired amount is usually chosen based on the film-forming performance of the resulting paint film empirically. In a preferred embodiment of the present invention, the aqueous carrier preferably represent about 25 wt % to about 31 wt % of the film-forming resin composition.

In an embodiment of the present invention, the film-forming resin composition may further include the commonly used additional additives. Suitable additional additives may include wetting and dispersing agents, defoamers, leveling agents, rust inhibitors, adhesion promoters, film forming aids, rheology modifiers, pigments, or any combination thereof. Preferably, suitable additional additives include defoamers, dispersants, pigments, fillers, rust inhibitors, adhesion promoters, or any combination thereof.

The content of each optional component is sufficient to achieve its intended purpose, but preferably, such content does not adversely affect the film-forming resin composition or the coating obtained therefrom. According to certain embodiments of the present invention, the total amount of additional additives is in the range of about 0 wt % to about 60 wt %, preferably about 0.1 wt % to about 55 wt %, more preferably about 10 wt % to about 30 wt % relative to the total weight of the film-forming resin composition.

The preparation of the film-forming resin composition of the present invention may be achieved by any suitable mixing method known to those of ordinary skill in the art. For example, the film-forming resin composition can be prepared by adding the epoxy resin matrix, rubber-modified epoxy resin, aqueous carrier, ferrophosphorus powder and additional additives (if any) to the container, and then stirring the resulting mixture uniformly.

### Aqueous Curing System

In some embodiments of the present disclosure, the aqueous curing system for the two-component epoxy resin shop primer comprises an epoxy reactive curing agent, and the epoxy reactive curing agent is selected from an aliphatic polyamine, a fatty amine adduct, an amidoamine, an amino polyamide resin, an alicyclic amine, an aromatic amine, an arylalkylamine, a Mannich base, a ketimine, dicyandiamide or any combination thereof.

In some embodiments of the present disclosure, the curing agent is known in the art, such as COATING PROCESS, Edited by Dengliang Liu, Version 4, 2010, pages 258-302, which is incorporated herein by reference.

In an embodiment of the present disclosure, the aqueous curing system, based on the total weight of the curing system, comprise 50-70 wt % of an epoxy reactive curing agent and 30-50 wt % of a solvent, the solvent being water or a solvent miscible with water.

In embodiments of the present invention, the epoxy reactive curing agent is commercially available. As an example of the epoxy reactive curing agent, any suitable commercially available product, such as Hansen 6870, can be used.

According to some embodiments of the present disclosure, relative to the total weight of the film forming resin composition, the amount of the epoxy reactive curing agent can be varied in the range of 8 wt % to 20 wt %. In general, when the amount of the epoxy reactive curing agent is less than 8 wt % relative to the total weight of the film forming resin composition, the curing performance of the coating will be poor. When the amount of the epoxy reactive curing agent is greater than 20 wt % relative to the total weight of the film forming resin composition, the operating performance of the obtained epoxy resin shop primer and/or the mechanical properties of the resulting coating will be decreased. According to actual demands, during the preparation process of the epoxy reactive curing agent and/or the film forming resin composition, additional inert diluent may be added which will not affect the reactivity of the above curing agent and film forming resin composition, such as to reduce the viscosity of the components. Therefore, the weight percentage of the curing agent relative to the total weight of the film forming resin composition is not limited to the above range, and can be adjusted according to actual demand.

According to the present disclosure, the aqueous epoxy resin shop primer can be prepared by simply mixing the epoxy reactive curing agent with an appropriate amount of water to obtain an aqueous curing system, followed by mixing the film forming resin composition with the aqueous curing system in a mixing device at a predetermined weight ratio before application. The resulting epoxy resin based shop primer can be applied in a variety of ways that are familiar to those skilled in the art, including spraying (e.g., air assisted, airless or electrostatic spraying), brushing, rolling, flooding and dipping. In an embodiment of the present disclosure, the resulting epoxy resin based shop primer is coated by spraying. The epoxy resin based shop primer can be applied in various wet film thickness. In an embodiment of the present disclosure, the epoxy resin based shop primer is applied in such a wet film thickness that the formed coating has a dry thickness preferably from about 20 to about 200 μm and more preferably from about 20 to about 100 μm. The applied paint may be cured by air drying or by accelerating drying with various drying devices (e.g., ovens) that are familiar to those skilled in the art. The preferred heating temperature for curing epoxy resin based shop primer is about 60° C. to about 100° C., and more preferably is about 60° C. to about 80° C., and the preferred heating time for curing epoxy resin based shop primer is at least 3 minutes to less than 60 minutes, less than 45 minutes, less than 40 minutes. Heating time will tend to decrease with increasing temperature or increasing air flow.

According to some embodiments of the present disclosure, the shop primer of the present disclosure is applied and cured in an amount to form a 20 micron dry paint film thickness, and the obtained paint film exhibits a water permeability of 0.3 ml or less when it is subjected to a water permeability test according to JG/T210-2018.

According to some embodiments of the present disclosure, the shop primer of the present disclosure is applied and cured in an amount to form a 20 micron dry paint film thickness, and the obtained paint film exhibits an oxygen permeability of 30 cm³/m²·24 h·0.1 MPa or less when it is subjected to an oxygen permeability test according to GB/T1038-2000.

According to some embodiments of the present disclosure, the shop primer of the present disclosure is applied and cured in an amount to form a 20 micron dry paint film thickness, and the obtained paint film exhibits a water permeability of 0.3 ml or less when it is subjected to a water permeability test according to JG/T210-2018, and an oxygen permeability of 30 cm³/m²·24 h·0.1 MPa or less when it is subjected to an oxygen permeability test according to GB/T1038-2000.

### Article

In another aspect, the present disclosure provides an article, comprising a metal substrate having at least one major surface; and a shop primer layer formed by the aqueous epoxy resin-based shop primer of the present application directly applied to the major surface.

As a metal substrate for manufacturing the article of the present invention, any suitable metal substrate known in the art can be used. As an example, the metal substrate is selected from steel, iron, aluminum, zinc and their alloys.

According to the present invention, the article can be prepared, for example, by the following steps: (1) providing a polished metal substrate; (2) using a coating and curing process to sequentially coat and form one or more epoxy resin based shop primers of the invention on the metal substrate to provide corrosion resistance for the metal substrate.

According to the present invention, the metal products thus obtained can be further treated with an additional primer and anticorrosive topcoat, and can be used for the following terminal applications, including but not limited to refrigerated containers and unrefrigerated shipping containers (e.g., dry cargo containers) from suppliers or manufacturers including China International Marine Containers (CIMC), Graaff Transportsysteme Gmbh, Maersk Line and others that will be familiar to persons having ordinary skill in the art, chassis, trailers including semitrailers, rail cars, truck bodies, ships, bridges, building skeletons, and other prefabricated or site-fabricated metal articles needing temporary indoor or outdoor corrosion inhibition during fabrication. Additional uses include metal angles, channels, beams (e.g., I-beams), pipes, tubes, plates and other components that may be welded into these and other metal articles.

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available and used directly without further treatment.

### Test Methods

Water Permeability

The water permeability was measured with a water permeability test according to JG/T210-2018 after the shop primer of the present disclosure was applied and cured in an amount to form a 20 micron dry paint film thickness.

Oxygen Permeability

The oxygen permeability was measured with an oxygen permeability test according to GB/T1038-2000 after the shop primer of the present disclosure was applied and cured in an amount to form a 20 micron dry paint film thickness.

Salt Spray Resistance

The shop primer of the present invention was coated and cured, and then the resulting paint film was measured according to GB/T 1771-2007 for its salt spray resistance.

Heat and Moisture Resistance

The shop primer of the present invention was coated and cured, and then the resulting paint film was measured according to GB/T 1740-2007 for its heat and moisture resistance.

### EXAMPLES

### Example 1

### Preparation of Aqueous Epoxy Resin Based Shop Primer

As shown in Table 1, the components in component A and component B shown in Table 1 were mixed to obtain component A and component B respectively. Then, the obtained component A was mixed with the curing agent component B to form a two-component aqueous epoxy resin based shop primer according to examples 1 and 2 and comparative Examples 1 and 2, in which Examples 1 and 2 each comprises the epoxy resin matrix and the rubber modified epoxy resin; Comparative Example 1 comprises the epoxy resin matrix alone; and in Comparative Example 2, the epoxy resin matrix was simply mixed with an epoxy toughening agent. In Table 1, the epoxy resin matrix as used was EPIKOTE Resin 6520-wh-53 from Hexion Corporation, and the rubber modified epoxy resin as used was EPIKOTE Resin 6530-wh-53 from Hexion Corporation.

TABLE 1

| | Material | Ex1 | Ex2 | CEX1 | CEX 2 |
|---|---|---|---|---|---|
| Component A | | 100 | 115 | 100 | 100 |
| 1 | Deionized water | 6.3 | 6.3 | 6.3 | 6.3 |
| 2 | Industrial alcohol | 19.8 | 34.8 | 19.8 | 19.8 |
| 3 | Organic solvents | 1.5 | 1.5 | 1.5 | 1.5 |
| 4 | Defoamer | 0.3 | 0.3 | 0.3 | 0.3 |
| 5 | Dispersant | 1.5 | 1.5 | 1.5 | 1.5 |
| 6 | Fumed silica | 0.5 | 0.5 | 0.5 | 0.5 |
| 7 | Ferrophosphorus powder | 5.0 | 5.0 | 5.0 | 5.0 |
| 8 | Iron oxide red | 10 | 8 | 10 | 10 |
| 9 | Talc | 3.0 | 5.0 | 3.0 | 3.0 |
| 10 | Wollastonite powder | 4.0 | 4.0 | 4.0 | 4.0 |
| 11 | Aluminium triphosphate | 15 | 15 | 15 | 15 |
| 12 | Mica powder | 1.0 | 1.0 | 1.0 | 1.0 |
| 13 | Aqueous epoxy resin matrix | 24.0 | 24.0 | 30.5 | 30.5 |
| 14 | Aqueous rubber modified | 6.5 | 6.5 | / | / |
| | epoxy resin | | | | |
| 15 | Epoxy toughening agent | / | / | / | 6.5 |
| 16 | silane coupling agent | 1.0 | 1.0 | 1.0 | 1.0 |
| 17 | Wetting agent for substrate | 0.4 | 0.4 | 0.4 | 0.4 |
| 18 | Black paste | 0.2 | 0.2 | 0.2 | 0.2 |
| Component B | | 10 | 10 | 10 | 10 |
| 1 | Aqueous epoxy curing agent | 7.49 | 6.51 | 6.51 | 6.51 |
| 2 | Deionized water | 2.37 | 3.37 | 3.37 | 3.37 |
| 3 | Rust inhibitor | 0.14 | 0.12 | 0.12 | 0.12 |

### Example 2

### Water Permeability and Oxygen Permeability of Aqueous Epoxy Resin Based Shop Primer

The aqueous epoxy resin based shop primer as obtained from example 1 of Table 1 was coated and cured to form a paint film with 20 μm dry paint film thickness, and the paint film was measured according to JG/T210-2018 and GB/T 1038-2000, respectively for its water permeability and oxygen permeability. The results were summarized in Table 2.

TABLE 2

| | Dry Film thickness | Standard | Results |
|---|---|---|---|
| water permeability | 20 μm | JG/T210-2018 | 0.2 ml |
| oxygen permeability | 20 μm | GB/T 1038-2000 | 26 cm³/m² · 24 h · 0.1 Mpa |

It was shown from the above results that the paint film formed by the aqueous epoxy resin based shop primer could effectively prevent water vapor from reaching the substrate surface and effectively prevent oxygen from reaching the metal surface.

### Example 3

### Corrosion Resistance of Shop Primer

In order to verify the corrosion resistance of the shop primer produced by the present invention, the aqueous epoxy resin shop primer as obtained in the above examples 1-2 and comparative examples 1-2 were compared with the zinc free shop primer comprising a styrene acrylic emulsion as a resin component thus obtained according to CN102211430B in terms of salt spray resistance and moisture and heat resistance. Recipe for formulating the zinc free shop primer comprising a styrene acrylic emulsion as a resin component according to CN102211430B was listed in Table 3 below and results were listed in table 4.

TABLE 3

| Items | Starting materials | CEx 3/parts |
|---|---|---|
| 1 | Styrene acrylic emulsion | 31.39 |
| 2 | Dispersant | 1.0 |
| 3 | Defoamer | 0.78 |
| 4 | Surfactant | 0.39 |
| 5 | BCS solvent | 0.67 |
| 6 | Deionized water | 7 |
| 7 | Carbon Black | 4.15 |
| 8 | Aluminium triphosphate | 4.15 |
| 10 | Styrene acrylic emulsion | 37.11 |
| 11 | Deionized water | 2.09 |
| 12 | Ammonia (26%) | 0.5 |
| 13 | Dodecyl alcohol ester | 0.95 |
| 14 | Defoamer | 0.05 |
| 15 | BCS solvent | 7.17 |
| 16 | Nitrous acid (10%) | 2.6 |

TABLE 4
Salt spray resistance and moisture and
heat resistance of various shop primers

| | Ex 1 | Ex 2 | CEx 1 | CEx 2 | CEx3 |
|---|---|---|---|---|---|
| Salt Spray Resistance | good | good | fair | good | poor |
| Moisture and Heat Resistance | good | good | good | fair | fair |

It was shown from the above results that in the formulation of the aqueous epoxy resin based shop primer, the film-forming resin composition comprised an epoxy resin component containing an epoxy resin matrix and a rubber modified epoxy resin so that the resulting paint film exhibited excellent heat and moisture resistance and corrosion resistance, compared with the paint film from other aqueous zinc free shop primers comprising a resin component containing an epoxy resin matrix alone, a resin component containing an epoxy resin matrix and an epoxy toughening agent, or a resin component containing a styrene acrylic emulsion.

While the invention has been described with respect to a number of embodiments and examples, those skilled in the art, having benefit of this disclosure, will appreciate that other embodiments can be devised which do not depart from the scope and spirit of the invention as disclosed herein.

What is claimed is:

1. An aqueous epoxy resin based shop primer comprising:
a) a film-forming resin composition comprising: i) an epoxy resin component; and ii) an aqueous carrier;
b) an aqueous curing system comprising an epoxy reactive curing agent;
wherein the epoxy resin component comprises: an epoxy resin matrix and a rubber modified epoxy resin; and
wherein the shop primer is substantially free of zinc.

2. The aqueous epoxy resin based shop primer of claim 1 wherein the rubber modified epoxy resin has an epoxy equivalent in the range of 450 to 620 g/eq.

3. The aqueous epoxy resin based shop primer according to claim 1, wherein the rubber-modified epoxy resin has a glass transition temperature of 10° C. or lower, preferably has a glass transition of 0° C. or lower.

4. The aqueous epoxy resin based shop primer according to claim 1, wherein the rubber-modified epoxy resin is obtained by toughening a bisphenol-A type epoxy resin with a rubber molecule.

5. The aqueous epoxy resin based shop primer of claim 4, wherein the rubber molecule is selected from one or more of carboxyl terminated nitrile rubber, hydroxyl terminated nitrile rubber, polysulfide rubber, nitrile rubber based isocyanate prepolymer, hydroxyl terminated polybutadiene, polyether rubber, urethane rubber and silicone rubber.

6. The aqueous epoxy resin based shop primer of claim 4, wherein the bisphenol-A type epoxy resin has an epoxy equivalent in the range of from 500 to 575 g/eq.

7. The aqueous epoxy resin based shop primer according to claim 1, wherein the rubber modified epoxy resin is present in the form of a dispersion in an aqueous solvent, preferably having a solid content of 40 to 65 wt %.

8. The aqueous epoxy resin based shop primer of claim 1, wherein the epoxy resin matrix has an epoxy equivalent in the range of from 400 g/eq to 2500 g/eq.

9. The aqueous epoxy resin based shop primer of claim 1 wherein the epoxy resin matrix is selected from one or more of diglycidyl ethers of polyhydric phenols;
diglycidyl ethers of polyhydric alcohols; and polyglycidyl ethers of phenolic resin.

10. The aqueous epoxy resin based shop primer of claim 9, wherein the epoxy resin matrix is diglycidyl ethers of polyhydric phenols having the following structural formula (I): 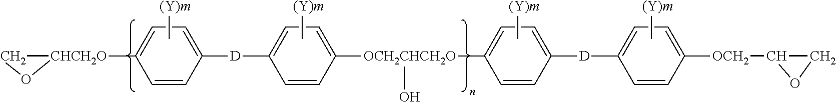
wherein
D represents —S—, —S—S—, —SO—, —SO₂—, —CO₂—, —CO—, —O— or C1-C10 alkylene,
Y each independently represents halogen, or an optionally substituted monovalent C₁-C₁₀ hydrocarbon group,
m each independently represents 0, 1, 2, 3 or 4,
n is an integer from 0 to 4.

11. The aqueous epoxy resin based shop primer of claim 1 wherein the epoxy resin matrix is present in the form of an aqueous epoxy resin emulsion.

12. The aqueous epoxy resin based shop primer of claim 11 wherein the aqueous epoxy resin emulsion has a solids content of 40 to 60 wt %.

13. The aqueous epoxy resin based shop primer of claim 1 wherein the aqueous carrier comprises an alcohol solvent and the alcohol solvent comprises ethanol, propanol, 1-methoxy-2-propanol or any combination thereof.

14. The aqueous epoxy resin based shop primer of claim 1 further comprising an electrically conductive filler, wherein the electrically conductive filler comprises ferrophosphorus powder.

15. The aqueous epoxy resin based shop primer of claim 14, wherein the film-forming resin composition comprises, relative to the total weight of the film-forming resin composition
22-25 wt % of the epoxy resin matrix;
5-8 wt % of the rubber modified epoxy resin;
4-7 wt % of the electrically conductive filler;
25-31 wt % of the aqueous carrier; and
20-30 wt % of additional additives.

16. The aqueous epoxy resin based shop primer of claim 1 wherein the epoxy reactive curing agent comprises an aliphatic polyamine, a fatty amine adduct, an amidoamine, an amino polyamide resin, an alicyclic amine, an aromatic amine, an arylalkylamine, a Mannich base, a ketimine, dicyandiamide or any combination thereof.

17. The aqueous epoxy resin based shop primer of claim 1, wherein the shop primer is applied and cured in an amount to form a 20 micron dry paint film thickness, and the obtained paint film exhibits a water permeability of 0.3 ml or less when it is subjected to a water permeability test according to JG/T210-2018, and/or exhibits an oxygen permeability of 30 cm³/m²·24 h·0.1 MPa or less when it is subjected to an oxygen permeability test according to GB/T1038-2000.

18. An article comprising
a metal substrate having at least one major surface; and
a shop primer layer formed by the aqueous epoxy resin-based shop primer of claim 1 directly applied to the major surface.

19. The article of claim 18, wherein the metal substrate is selected from the group consisting of steel, iron, aluminum, zinc, and alloys thereof.
